(19) United States
(12) Patent Application Publication
(10) Pub. No.: US 2026/0032343 A1
(43) Pub. Date: Jan. 29, 2026

(54) CONTROL APPARATUS, IMAGE PICKUP APPARATUS, CONTROL METHOD, AND STORAGE MEDIUM

(71) Applicant: CANON KABUSHIKI KAISHA, Tokyo (JP)

(72) Inventor: MINAMI FURUTA, Tokyo (JP)

(21) Appl. No.: 19/255,092

(22) Filed: Jun. 30, 2025

(30) Foreign Application Priority Data
Jul. 29, 2024 (JP) 2024-122170

(51) Int. Cl. H04N 23/68; H04N 23/73

(52) U.S. Cl. CPC H04N 23/683; H04N 23/73

(57) ABSTRACT

A control apparatus includes a memory storing instructions, and a processor that, upon execution of the instructions, is configured to acquire information on an exposure period, and control, based on the information, a first image stabilizing unit and a second image stabilizing unit during the exposure period. The exposure period includes a first period and a second period. The first image stabilizing unit has a smaller stroke and is more highly responsive than the second image stabilizing unit. The processor is configured to drive the first image stabilizing unit during the first period, and drive the second image stabilizing unit and not drive the first image stabilizing unit during the second period.

### BACKGROUND

### Field of the Technology

The present disclosure relates to a control apparatus, an image pickup apparatus, a control method, and a storage medium.

### Description of the Related Art

In imaging using the image pickup apparatus, there is a certain period in a single exposure period during which minute and high-speed image blur is noticeable. Japanese Patent Application Laid-Open No. 2021-113836 discloses an image pickup apparatus configured to control an image stabilizing unit by adding correction data for correcting impacts caused by the shutter drive and the charge vibration during imaging.

However, the image pickup apparatus disclosed in Japanese Patent Application Laid-Open No. 2021-113836 can reduce the influence of the shutter drive and the charge vibration during imaging, but does not consider image stabilization according to a status change during exposure.

### SUMMARY

A control apparatus according to one aspect of the present disclosure includes a memory storing instructions, and a processor that, upon execution of the instructions, is configured to acquire information on an exposure period, and control, based on the information, a first image stabilizing unit and a second image stabilizing unit during the exposure period. The exposure period includes a first period and a second period. The first image stabilizing unit has a smaller stroke and is more highly responsive than the second image stabilizing unit. The processor is configured to drive the first image stabilizing unit during the first period, and drive the second image stabilizing unit and not drive the first image stabilizing unit during the second period. An image pickup apparatus having the above control apparatus, and a control method corresponding to the above control apparatus, and a storage medium storing a program that causes a computer to execute the above control method also constitute another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are a schematic sectional view and a schematic block diagram of an imaging system according to each embodiment.

FIG. 2 explains the time passage and the operation of an image stabilizing unit during imaging using rear curtain synchronization in a first embodiment.

FIG. 3 explains the time passage and the operation of an image stabilizing unit during imaging using front curtain synchronization in a second embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

### First Embodiment

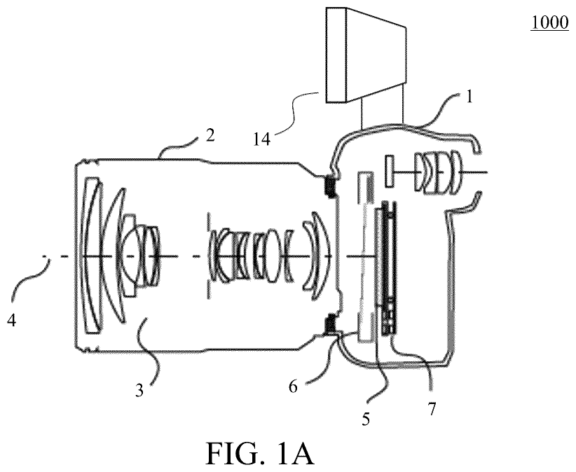

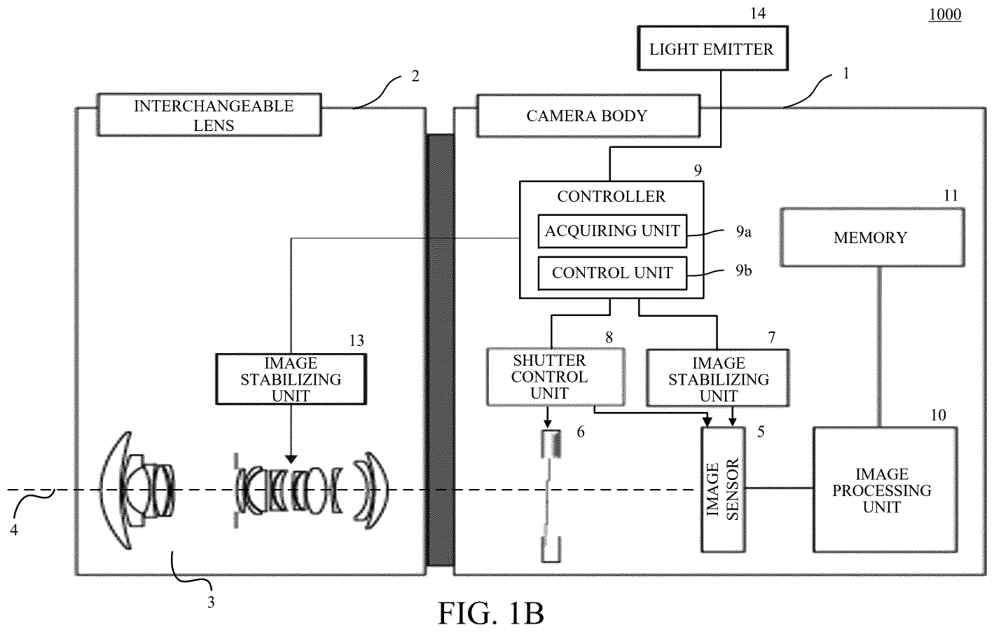

Referring now to FIGS. 1A and 1B, a description will be given of the configuration and operation of an imaging system 1000 according to a first embodiment of the present disclosure. FIG. 1A is a schematic sectional view of the imaging system 1000. FIG. 1B is a schematic block diagram of the imaging system 1000. The imaging system 1000 is a so-called lens interchangeable type single-lens reflex camera system that includes a camera body (image pickup apparatus) 1 and an interchangeable lens (lens apparatus) 2 that is attachable to and detachable from the camera body 1. The camera body 1 and the interchangeable lens 2 can be connected via a camera mount and function as the imaging system 1000. However, this embodiment is not limited to this example, and is also applicable to an image pickup apparatus in which the camera body and the lens apparatus are integrated.

The interchangeable lens 2 includes an imaging optical system 3. A light beam from an object passes through the imaging optical system 3 and is imaged on an image sensor 5 in the camera body 1. The image sensor 5 photoelectrically converts the light beam (optical image) into an image signal. The image signal is guided to an image processing unit 10. The image processing unit 10 performs various development processing for the image signal. A memory 11 stores the image processed by the image processing unit 10 as an image file.

In order to prevent a captured image from being deteriorated (to reduce image blur) due to vibrations such as camera shake applied to the imaging system 1000, the interchangeable lens 2 includes an image stabilizing unit (first image stabilizing unit) 13, and the camera body 1 includes an image stabilizing unit (second image stabilizing unit) 7.

The camera body 1 includes a controller (control apparatus) 9 configured to control each part in the imaging system 1000. The controller 9 includes an acquiring unit 9a and a control unit (image stabilizing control unit) 9b. The acquiring unit 9a acquires information on an exposure period (a period from when the shutter starts opening to when it finishes closing). The control unit 9b controls the image stabilizing units 13 and 7 during the exposure period based on the information on the exposure period. The control unit 9b controls each of the image stabilizing units 7 and 13 to move in a plane orthogonal to an optical axis 4, thereby reducing (eliminating) image blur caused by vibrations such as camera shake. The imaging system 1000 includes a light emitter 14. The light emitter 14 emits light during imaging based on instructions from the controller 9.

The image stabilizing unit 13 uses a piezoelectric element as its drive unit, so it has a relatively small stroke and is highly responsive. Thus, the image stabilizing unit 13 can reduce faster image blur. On the other hand, the image stabilizing unit 7 uses a voice coil motor as its drive unit, so it has a relatively large stroke and is less responsive than the image stabilizing unit 13. Thereby, the image stabilizing unit 7 can reduce larger image blur.

Thus, in this embodiment, the image stabilizing unit 13 as the first image stabilizing unit has a smaller stroke and is more highly responsive than the image stabilizing unit 7 as the second image stabilizing unit. However, this embodiment is not limited to this example, and the image stabilizing unit 7 may be the first image stabilizing unit, and the image stabilizing unit 13 may be the second image stabilizing unit. Alternatively, the image stabilizing unit 7 may serve as both the first and second image stabilizing units. Similarly, the image stabilizing unit 13 may serve as both the first and second image stabilizing units.

During still image capturing, the start and end of exposure can be determined by the mechanical front curtain and mechanical rear curtain of a shutter apparatus (focal plane shutter apparatus) 6 driving on the object side of the image sensor 5. A mode in which the exposure operation is performed using the mechanical front curtain and mechanical rear curtain is called a mechanical front curtain drive mode. A shutter control unit 8 controls the drive of the mechanical front curtain and mechanical rear curtain of the shutter apparatus 6 based on commands from the controller 9. However, in this embodiment, a mode in which the exposure operation is performed is not limited to this example, and another mode such as an electronic shutter mode may also be used.

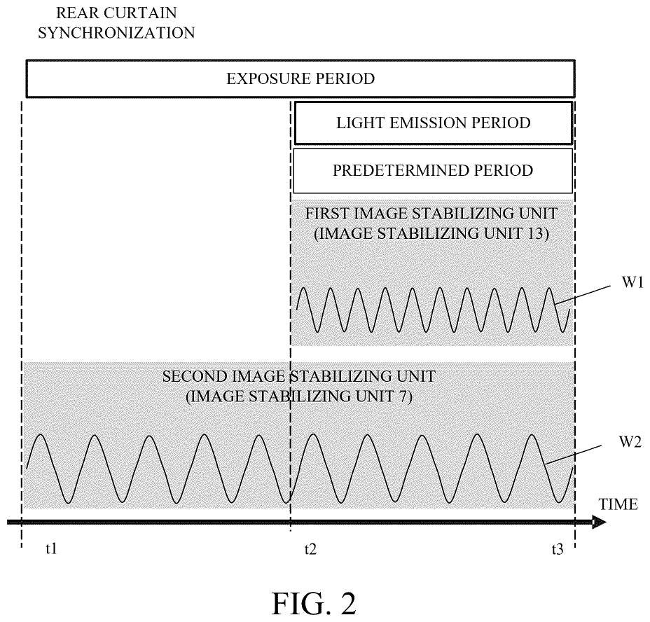

Referring now to FIG. 2, a description will be given of imaging performed using a light emitter 14. FIG. 2 explains the time passage and the operations of the image stabilizing units 13 and 7 during imaging performed using rear curtain synchronization, which can emit light just before the mechanical rear curtain starts closing in the shutter apparatus 6 and irradiate the object with strobe light after a light trail or the like is captured.

In FIG. 2, the horizontal axis represents time. Gray bands (waveforms W1 and W2) represent the drive statuses of the image stabilizing units 13 and 7 in each of the exposure period and emission period (predetermined period, first period). t1 indicates the start time of the exposure period (second period), t2 indicates the start time of the predetermined period (first period) (end time of the second period), and t3 indicates the end time of the exposure period and the predetermined period (first period). The waveform W1 indicates high-speed drive with a small stroke of the image stabilizing unit 13. The waveform W2 indicates the drive of the image stabilizing unit 7 with a large stroke, which is slower than the image stabilizing unit 13. The waveforms W1 and W2 illustrated in FIG. 2 are examples for explaining the characteristics of the drive of the image stabilizing unit 7 and the drive of the image stabilizing unit 13, and another shape may be used as long as the drive stroke and speed satisfy the above relationship.

The image stabilizing unit 7 is controlled to move by the control unit 9b from the start of exposure at time t1. When light emission by the light emitter 14 starts, the image stabilizing unit 13 is also controlled to move. The predetermined period during which the image stabilizing unit 13 moves starts at time t2 (after the end of the second period), and the predetermined period is previously determined (before exposure starts or during imaging preparation). When the light emission ends at time t3, the exposure period ends and the image stabilizing units 7 and 13 are controlled to stop.

In this embodiment, the image stabilizing unit 7 is controlled to move during the light emission period (predetermined period) by the light emitter 14. However, this embodiment is not limited to this example, and the image stabilizing unit 7 may be controlled to stop during the light emission period (predetermined period).

This embodiment drives the image stabilizing unit 13 during a period during which the light emitter 14 emits light for rear curtain synchronization, and therefore can properly respond to high-frequency image blur that can be noticeable during short-period light emission. The periods during which the image stabilizing unit 7 is driving can properly reduce low-frequency image blur and large-amplitude image blur that cannot be reduced by the image stabilizing unit 13. Driving the image stabilizing unit 13 only during a part of the exposure period can reduce power consumption and noise caused by driving the image stabilizing unit 13.

### Second Embodiment

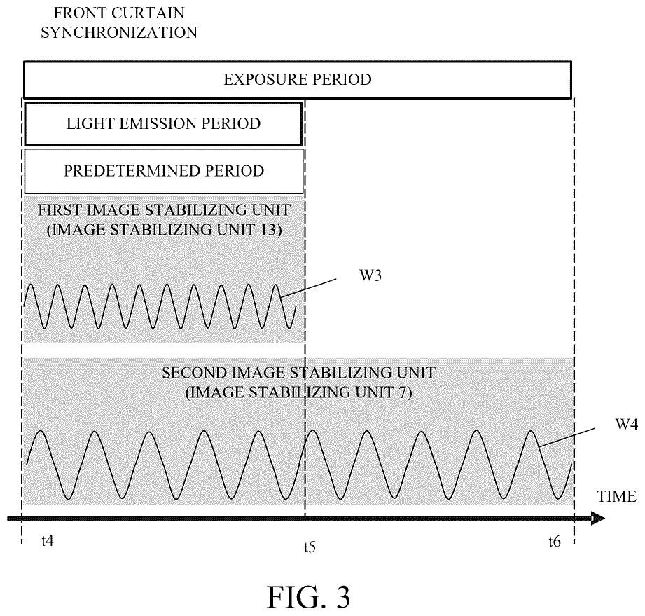

Referring now to FIG. 3, a description will be given of a second embodiment according to the present disclosure. The basic configuration of the imaging system according to this embodiment is similar to that of the imaging system 1000 described in the first embodiment with reference to FIGS. 1A and 1B, and thus a description thereof will be omitted.

FIG. 3 explains the time passage and the operations of the image stabilizing units 13 and 7 during imaging using front curtain synchronization in which the front curtain shutter of the shutter apparatus 6 drives, the shutter is fully opened, and light is emitted at the same time.

In FIG. 3, the horizontal axis indicates time. Gray bands (waveforms W3 and W4) represent the drive statuses of the image stabilizing units 13 and 7 in each of the exposure period and the light emission period (predetermined period, first period). t4 indicates the start time of the exposure period and the predetermined period (first period), t5 indicates the end time of the predetermined period (first period) (start time of the second period), and t6 indicates the end time of the exposure period (end time of the second period). The waveform W3 indicates high-speed drive with a small stroke of the image stabilizing unit 13. The waveform W4 indicates drive of the image stabilizing unit 7 with a large stroke, which is slower than that of the image stabilizing unit 13. The waveforms W3 and W4 illustrated in FIG. 2 are examples for explaining the characteristics of the drive of the image stabilizing unit 7 and the drive of the image stabilizing unit 13, and another shape may be used as long as the drive stroke and speed satisfy the above relationship.

At time t4, the shutter is fully opened, and at the same time, the light emitter 14 starts emitting light, and at the same time, the control unit 9b controls the image stabilizing units 13 and 7 to move, respectively. After the light emission period ends at time t5, only the image stabilizing unit 7 is controlled to move. However, this embodiment is not limited to this example, and the image stabilizing unit 13 may be controlled to move after time t5 within a range in which the predetermined period is not longer than the exposure period. In this embodiment, the image stabilizing unit 7 is controlled to move during the light emission period (predetermined period) by the light emitter 14, but is not limited to this example. The image stabilizing unit 7 may be controlled to stop during the light emission period.

This embodiment drives the image stabilizing unit 13 during the period during which the light emitter 14 emits light for front curtain synchronization, and thus can properly respond to high-frequency image blur that may be noticeable during short-period light emission. The period in which the image stabilizing unit 7 is driving can properly reduce low-frequency image blur and large-amplitude image blur that cannot be reduced by the image stabilizing unit 13. Driving the image stabilizing unit 13 only during a part of the exposure period can reduce power consumption and noise caused by driving the image stabilizing unit 13.

Thus, in each embodiment, the control unit 9b drives the first image stabilizing unit in the first period, and drives the second image stabilizing unit and does not drive the first image stabilizing unit in the second period. The control unit 9b may drive the second image stabilizing unit together with the first image stabilizing unit in the first period.

The first period may change according to the light emission period of the light emitter 14. The first period may correspond to a light emission period and starts after the second period ends, and the control unit 9b may drive the second image stabilizing unit and may not drive the first image stabilizing unit in the second period, and drives at least the first image stabilizing unit in the first period (rear curtain synchronization). Alternatively, the first period may correspond to a light emission period and end before the second period starts, and the control unit 9b may drive at least the first image stabilizing unit in the first period and drive at least the second image stabilizing unit in the second period (front curtain synchronization).

In each embodiment, the predetermined period corresponds to the light emission period (the light emission period and the predetermined period are approximately the same), but this embodiment is not limited to this example. A part of the light emission period may be set as the predetermined period within an arbitrary range that can reduce high-frequency blurs that becomes noticeable within the light emission period. In each embodiment, a predetermined period that is a part of the exposure period may be set, including a period different from the light emission period.

In each embodiment, the control unit 9b may change the control of driving at least one of the first and second image stabilizing units according to whether or not the light emitter 14 is caused to emit light during the exposure period. Thereby, more proper image stabilization can be performed according to whether or not the light emitter 14 is operated.

In each embodiment, the control unit 9b may change the control of driving at least one of the first and second image stabilizing units according to the light emission period of the light emitter 14. For example, the control unit 9b drives the first image stabilizing unit in a case where the light emission period is longer than the predetermined light emission period, and does not drive the first image stabilizing unit in a case where the light emission period is shorter than the predetermined light emission period. In a case where the light emission period is short, power consumption can be reduced by not operating the first image stabilizing unit.

In each embodiment, the control unit 9b may change the control of driving at least one of the first and second image stabilizing units according to the exposure period. For example, in a case where the exposure period is longer than a predetermined exposure period, the control unit 9b drives the first image stabilizing unit in the first period, drives the second image stabilizing unit and does not drive the first image stabilizing unit in the second period. For example, in a case where the exposure period is shorter than a predetermined exposure period, the control unit 9b drives the second image stabilizing unit and does not drive the first image stabilizing unit in the first period. In a case where the exposure period is short, the control unit 9b does not drive the first image stabilizing unit, thereby reducing power consumption.

In each embodiment, the control unit 9b may change the control of driving at least one of the first and second image stabilizing units when the light emitter 14 is caused to emit light according to a user setting. Thereby, more proper image stabilization can be performed according to the user's preferences.

Each embodiment drives the first image stabilizing unit to properly reduce high-frequency image blur in the light emission period, but the present disclosure can properly reduce high-frequency image blur only in a part of the exposure period. For example, in a case where a super-resolution image is generated by combining images obtained by performing multiple imaging at different positions of the image sensor 5 that are shifted by a predetermined amount using the second image stabilizing unit, image blur can be reduced in the micro-vibration period after the position of the image sensor 5 is shifted by the predetermined amount until the image sensor 5 stops. In this case, image blur in the micro-vibration period until the position of the image sensor 5 stops can be reduced by driving the first image stabilizing unit, so that exposure can be started in the micro-vibration period of the image sensor 5, and multiple imaging can be performed at short time intervals. The micro-vibration period and vibration waveform until the image sensor 5 stops after the position of the image sensor 5 is shifted by the predetermined amount may be previously obtained by an experiment or the like, and the length of the period for driving the first image stabilizing unit and information on the driving waveform may be stored in the memory of the controller 9. The user may be allowed to select the period for driving the first image stabilizing unit in the exposure period. For example, a bar corresponding to the length of the exposure period may be displayed on a display unit provided on the camera body 1, and the user may select the timing for starting and stopping driving the first image stabilizing unit by touching the display unit. The method of selecting the period for driving the first image stabilizing unit by the user may be another method, such as a selecting method in which the user operates an operation unit of an external device other than the camera body 1.

Each embodiment can provide a control apparatus, an image pickup apparatus, a control method, and a storage medium, each of which can perform image stabilization according to a status change during exposure.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-122170, which was filed on Jul. 29, 2024, and which is hereby incorporated by reference herein in its entirety.

What is claimed is:

1. A control apparatus comprising:
a memory storing instructions; and
a processor that, upon execution of the instructions, is configured to:
acquire information on an exposure period, and
control, based on the information, a first image stabilizing unit and a second image stabilizing unit during the exposure period,
wherein the exposure period includes a first period and a second period,
wherein the first image stabilizing unit has a smaller stroke and is more highly responsive than the second image stabilizing unit, and
wherein the processor is configured to:
drive the first image stabilizing unit during the first period, and
drive the second image stabilizing unit and not drive the first image stabilizing unit during the second period.

2. The control apparatus according to claim 1, wherein the processor is configured to drive the second image stabilizing unit together with the first image stabilizing unit during the first period.

3. The control apparatus according to claim 1, wherein the exposure period is a period from when a shutter starts opening to when the shutter finishes closing.

4. The control apparatus according to claim 1, wherein the first period is determined before exposure starts.

5. The control apparatus according to claim 1, wherein the first period changes according to a light emission period of a light emitter.

6. The control apparatus according to claim 5, wherein the first period corresponds to the light emission period and starts after the second period ends, and
wherein the processor is configured to:
drive the second image stabilizing unit and not drive the first image stabilizing unit during the second period, and
drive at least the first image stabilizing unit during the first period.

7. The control apparatus according to claim 5, wherein the first period corresponds to the light emission period and ends before the second period starts, and
wherein the processor is configured to:
drive at least the first image stabilizing unit during the first period, and
drive at least the second image stabilizing unit during the second period.

8. The control apparatus according to claim 1, wherein the processor is configured to change control of drive of at least one of the first image stabilizing unit and the second image stabilizing unit according to whether or not a light emitter is to emit light during the exposure period.

9. The control apparatus according to claim 1, wherein the processor is configured to change control of drive of at least one of the first image stabilizing unit and the second image stabilizing unit according to a light emission period of a light emitter.

10. The control apparatus according to claim 9, wherein the processor is configured to:
drive the first image stabilizing unit in a case where the light emission period is longer than a predetermined light emission period, and
not drive the first image stabilizing unit in a case where the light emission period is shorter than the predetermined light emission period.

11. The control apparatus according to claim 1, wherein the processor is configured to change control of drive of at least one of the first image stabilizing unit and the second image stabilizing unit according to the exposure period.

12. The control apparatus according to claim 1, wherein in a case where the exposure period is longer than a predetermined exposure period, the processor is configured to:
drive the first image stabilizing unit during the first period, and
drive the second image stabilizing unit and not drive the first image stabilizing unit during the second period.

13. The control apparatus according to claim 1, wherein in a case where the exposure period is shorter than a predetermined exposure period, the processor is configured to drive the second image stabilizing unit and not drive the first image stabilizing unit during the first period.

14. The control apparatus according to claim 1, wherein the processor is configured to change control of drive of at least one of the first image stabilizing unit and the second image stabilizing unit when a light emitter emits light, according to a user setting.

15. The control apparatus according to claim 1, wherein the first period is selectable by a user.

16. An image pickup apparatus comprising:
a control apparatus; and
an image sensor,
wherein the control apparatus includes:
a memory storing instructions, and
a processor that, upon execution of the instructions, is configured to:
acquire information on an exposure period, and
control, based on the information, a first image stabilizing unit and a second image stabilizing unit during the exposure period,
wherein the exposure period includes a first period and a second period,
wherein the first image stabilizing unit has a smaller stroke and is more highly responsive than the second image stabilizing unit, and
wherein the processor is configured to:
drive the first image stabilizing unit during the first period, and
drive the second image stabilizing unit and not drive the first image stabilizing unit during the second period.

17. A control method comprising:
acquiring information on an exposure period, and
controlling, based on the information, a first image stabilizing unit and a second image stabilizing unit during the exposure period,
wherein the exposure period includes a first period and a second period,
wherein the first image stabilizing unit has a smaller stroke and is more highly responsive than the second image stabilizing unit, and
wherein the controlling includes:
driving the first image stabilizing unit during the first period, and
driving the second image stabilizing unit and not driving the first image stabilizing unit during the second period.

18. A non-transitory computer-readable storage medium storing a program that causes a computer to execute the control method of claim 17.
